(19) United States
(12) Patent Application Publication
(10) Pub. No.: US 2023/0130662 A1
(43) Pub. Date: Apr. 27, 2023

(54) METHOD AND APPARATUS FOR ANALYZING MULTIMODAL DATA

(71) Applicant: SAMSUNG SDS CO., LTD., Seoul (KR)

(72) Inventors: Jeong Hyung Park, Seoul (KR); Hyung Sik Jung, Seoul (KR); Kang Cheol Kim, Seoul (KR)

(21) Appl. No.: 17/972,703

(22) Filed: Oct. 25, 2022

(30) Foreign Application Priority Data
Oct. 26, 2021 (KR) 10-2021-0143791

(51) Int. Cl. G06N 3/04; G06N 3/08; G06V 10/44; G06V 10/74; G06V 10/774

(52) U.S. Cl. CPC G06N 3/0454; G06N 3/08; G06V 10/443; G06V 10/74; G06V 10/774; G06F 40/40

(57) ABSTRACT

An apparatus for analyzing multimodal data includes an image processor configured to generate an activation embedding vector based on an index of an activation map obtained from image data through a convolutional neutral network, a text processor configured to receive text data to generate a text embedding vector, a vector concatenator configured to concatenate the activation embedding vector and the text embedding vector to each other to generate a concatenated embedding vector, and an encoder configured to generate a multimodal representation vector in consideration of an influence between elements constituting the concatenated embedding vector based on self-attention.

### CROSS-REFERENCE TO RELATED APPLICATION AND CLAIM OF PRIORITY

This application claims the benefit under 35 USC § 119 of Korean Patent Application No. 10-2021-0143791, filed on Oct. 26, 2021 in the Korean Intellectual Property Office, the disclosure of which is incorporated herein by reference in its entirety.

### BACKGROUND

### 1. Field

Example embodiments of the present disclosure relate to a technology for analyzing multimodal data.

### 2. Description of Related Art

In multimodal representation learning, according to the related art, object detection (for example, R-CNN) is mainly utilized to extract features based on region of interest (RoI) of objects included in an image, and the extracted features are used in image embedding.

However, such a method is significantly dependent on the object detection, so that R-CNN trained for each domain is required. In this case, a label (for example, a bounding box) for an object detection test is additionally required to train R-CNN.

### SUMMARY

An aspect of the present disclosure is to provide a method and an apparatus for analyzing multimodal data.

According to an aspect of the present disclosure, an apparatus for analyzing multimodal data includes: an image processor configured to generate an activation embedding vector based on an index of an activation map obtained from image data through a convolutional neutral network; a text processor configured to receive text data to generate a text embedding vector; a vector concatenator configured to concatenate the activation embedding vector and the text embedding vector to each other to generate a concatenated embedding vector; and an encoder configured to generate a multimodal representation vector in consideration of an influence between elements constituting the concatenated embedding vector based on self-attention.

At least one of the image processor, the text processor, the vector concatenator, and the encoder may be a hardware, a software, or a combination thereof. For example, at least one of the image processor, the text processor, the vector concatenator, and the encoder may be implemented by a hardware, a software, or a combination thereof.

The image processor may generate an activation map set, including a plurality of activation maps for the image data, using a synthetic neutral network.

The image processor may perform global average pooling on the plurality of activation maps, constituting the activation map set, to calculate a feature value for each of the plurality of activation maps.

The image processor may select one or more activation maps in an order of descending the feature value, and may generate an index vector including indices of the selected one or more activation maps.

The image processor may embed the index vector to generate an activation embedding vector.

The encoder may determine whether an activation embedding vector and a text embedding vector, constituting the concatenated embedding vector, match each other, and may be trained based on an image-text matching (ITM) loss function calculated based on whether a result of the determination is correct.

The encoder may generate a text mask multimodal representation vector for a text mask concatenated embedding vector generated by masking at least one element, among elements of a text embedding vector constituting a concatenated embedding vector, and may be trained based on a masked language modeling (MLM) loss function calculated based on similarity between a masked element of the text mask concatenated embedding vector and an element, corresponding to the masked element, among elements of a text mask multimodal representation vector.

The encoder may generate an image mask multimodal representation vector for an image mask concatenated embedding vector, generated by masking at least one element, among elements of an activation embedding vector constituting a concatenated embedding vector, and may be trained based on a masked activation modeling (MAM) loss function calculated based on similarity between a masked element of the image mask concatenated embedding vector and an element, corresponding to the masked element, among elements of an image mask multimodal representation vector.

The image processor, the text processor, and the encoder may be trained based on the same loss function.

The loss function may be calculated based on an image-text matching (ITM) loss function, a masked language modeling (MLM) loss function, and a masked activation modeling (MAM) loss function.

According to another aspect of the present disclosure, a method for analyzing multimodal data includes: an image processing operation in which an activation embedding vector is generated based on an index of an activation map obtained from image data through a convolutional neural network; a text processing operation in which text data is received to generate a text embedding vector; a vector concatenation operation in which the activation embedding vector and the text embedding vector are concatenated to each other to generate a concatenated embedding vector; and an encoding operation in which a multimodal representation vector is generated in consideration of an influence between elements, constituting the concatenated embedding vector, based on self-attention.

In the image processing operation, an activation map set including a plurality of activation maps for the image data may be generated using a synthetic neural network.

In the image processing operation, global average pooling may be performed on a plurality of activation maps, constituting the activation map set, to calculate a feature value of each of the plurality of activation maps.

In the image processing operation, one or more activation maps maybe selected in an order of descending the feature value, and an index vector including indices of the selected one or more activation maps may be generated.

In the image processing operation, the index vector may be embedded to generate an activation embedding vector.

In the encoding operation, a determination may be made as to whether an activation embedding vector and a text embedding vector, constituting the concatenated embedding vector, match each other, and training may be performed based on an image-text matching (IMT) loss function calculated based on whether a result of the determination is correct.

In the encoding operation, a text mask multimodal representation vector for a text mask concatenated embedding vector generated by masking at least one element, among elements of a text embedding vector constituting a concatenated embedding vector, may be generated, and training may be performed based on a masked language modeling (MLM) loss function calculated based on similarity between a masked element of the text mask concatenated embedding vector and an element, corresponding to the masked element, among elements of a text mask multimodal representation vector.

In the encoding operation, an image mask multimodal representation vector for an image mask embedding vector generated by masking at least one element, among elements of an activation embedding vector constituting a concatenated embedding vector, may be generated, and training may be performed based on a masked activation modeling (MAM) loss function calculated based on similarity between a masked element of the image mask concatenated embedding vector and an element, corresponding to the masked element, among elements of an image mask multimodal representation vector.

In the image processing operation, the text processing operation, and the encoding operation, trainings may be performed based on the same loss function.

The loss function may be calculated based on an image-text matching (ITM) loss function, a masked language modeling (MLM) loss function, and a masked activation modeling (MAM) loss function.

### BRIEF DESCRIPTION OF THE DRAWINGS

The above and other aspects, features, and advantages of the present disclosure will be more clearly understood from the following detailed description, taken in conjunction with the accompanying drawings.

FIG. 1 is a diagram illustrating a configuration of an apparatus for analyzing multimodal data according to an example embodiment of the present disclosure.

FIGS. 2 and 3 are diagrams illustrating an example of an operation of an apparatus for analyzing multimodal data according to an example embodiment of the present disclosure.

FIG. 4 is a flowchart illustrating a method for analyzing multimodal data according to an example embodiment of the present disclosure.

FIG. 5 is a block diagram illustrating an example of a computing environment including a computing device according to an example embodiment of the present disclosure.

### DETAILED DESCRIPTION

Hereinafter, embodiments of the present disclosure will be described in detail with reference to the accompanying drawings. The following detailed description is provided for comprehensive understanding of methods, devices, and/or systems described herein. However, the methods, devices, and/or systems are merely examples, and the present disclosure is not limited thereto.

In the following description, a detailed description of well-known functions and configurations incorporated herein will be omitted when it may obscure the subject matter of the present disclosure. Further, the terms used throughout this specification are defined in consideration of the functions of the present disclosure, and can be varied according to a purpose of a user or manager, or precedent and so on. Therefore, definitions of the terms should be made on the basis of the overall context. It should be understood that the terms used in the detailed description should be considered in a description sense only and not for purposes of limitation. Any references to singular may include plural unless expressly stated otherwise. In the present specification, it should be understood that the terms, such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

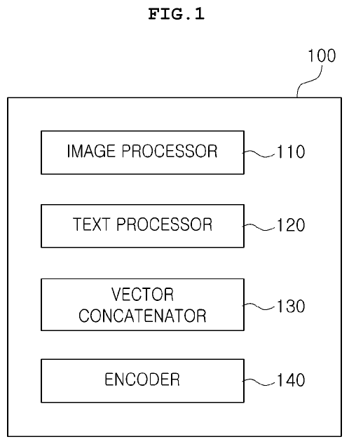

FIG. 1 is a diagram illustrating a configuration of an apparatus for analyzing multimodal data according to an example embodiment.

According to an example embodiment, an apparatus 100 for analyzing multimodal data may include an image processor 110, a text processor 120, a vector concatenator 130, and an encoder 140.

According to an example embodiment, the image processor 110 may generate an activation embedding vector based on an index of an activation map obtained from image data through a convolutional neural network.

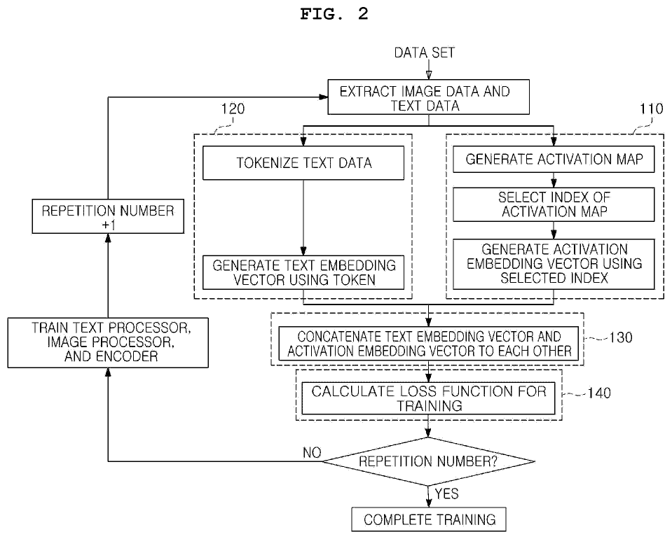

Referring to FIG. 2, the apparatus for analyzing multimodal data may receive a data set including image data and text data, and may respectively extract the image data and the text data from the received data set. Then, the apparatus for analyzing multimodal data may input the image data and the text data to the image processor 110 and the text processor 120, respectively.

According to an example, the image processor 110 may generate an activation map set including a plurality of activation maps for image data using a synthesis neural network. For example, the image processor 110 may encode received image data as a set of activation maps using an image encoder. As the image encoder, a convolutional neural network may be used. As an example, the image encoder may be a ResNet (for example, ResNet101)-based convolutional neural network.

According to an example embodiment, the image processor 110 may perform global average pooling on the plurality of activation maps, constituting the activation map set, to calculate a feature value for each of the plurality of activation maps. For example, the image processor 110 may perform global average pooling on activation maps, obtained through a convolutional neural network, to generate a feature value.

According to an example embodiment, the image processor 110 may select one or more activation maps in an order of descending feature values, and may generate an index vector including indices of the selected one or more activation maps. The selection of one or more activation maps in an order of descending feature values means that the first selection is an activation map having the greatest feature value, and the second selection is an activation map having the second-greatest feature value. That is, each of the selected one or more activation maps has a feature value greater than non-selected activation maps. For example, the image processor 110 may select Nₐ activation maps having highest generated feature values and may store indices of the selected activation maps.

According to an example embodiment, the image processor 110 may embed an index vector to generate an activation embedding vector. According to an example, the image processor 110 may convert a vector, including indices of activation maps, into an N-dimensional activation embedding vector using an activation embedder.

Through a series of such processes, image data input to the image processor 110 may be represented as an activation embedding vector A=(a₁, . . . , a_{Na}) ∈ [symbol] \hat{ }(Nₐ×N).

According to an example embodiment, the text processor 120 may receive text data to generate a text embedding vector.

According to an example, the text processor 120 may tokenize the received text data. For example, the text processor 120 may tokenize text data using a WordPiece tokenizer, and thus, may represent a sentence as a set of word tokens having independent meanings.

According to an example, the text processor 120 may convert tokenized text data, for example, a word token, into an N-dimensional vector using a text embedder. Thus, the text processor 120 may convert the received text data into a text embedding vector W=([CLS], w₁, . . . , w_{Nw}, [SEP]) ∈ [symbol] ^{(N}^{_{w}}^{+2)×N} where, [CLS] and [SEP] represent special tokens referring to a beginning and an end of a sentence, respectively.

According to an example embodiment, the vector concatenator 130 may concatenate an activation embedding vector and a text embedding vector to each other to generate a concatenated embedding vector. For example, the vector concatenator 130 may concatenate an activation embedding vector A=(a₁, . . . , a_{Na}) ∈ [symbol] \hat{ }(Nₐ×N), generated by the image processor 110, to a text embedding vector W=([CLS], w₁, . . . , w_{Nw}, [SEP]) ∈ [symbol] ^{(N}^{_{w}}^{+2)×N}, generated by the text processor 120, to generate a concatenated embedding vector V=([CLS], w₁, . . . , w_{Nw}, [SEP], a₁, . . . , a_{Na}) ∈ [symbol] ^{(N}^{_{w}}^{+2+N}^{ₐ}^{)×N}.

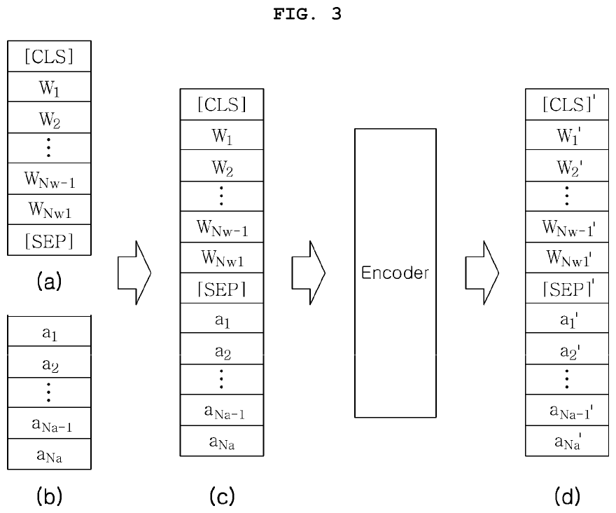

Referring to FIG. 3, the text processor 120 may generate a text embedding vector (a), and the image processor 110 may generate an activation embedding vector (b). Then, the vector concatenator 130 may concatenate the text embedding vector (a) and the activation embedding vector (b) to each other to generate a concatenated embedding vector (c). The generated concatenated embedding vector (c) may be input to the encoder 140.

According to an example embodiment, the encoder 140 may generate a multimodal representation vector in consideration of an influence between elements constituting a concatenated embedding vector based on self-attention.

According to an exemplary embodiment, the encoder 140 determines whether an activation embedding vector and a text embedding vector, constituting a concatenated embedding vector, match each other and may be trained based on an image-text matching (IMT) loss function calculated based on whether a result of the determination is correct.

According to an example, the encoder 140 may receive the concatenated embedding vector to perform IMT determining whether the text embedding vector (for example, W) and the activation embedding vector (for example, A), included in the concatenated embedding vector, match each other (y=1) or do not match each other (y=0).

According to an example, when the encoder 140 performs ITM, an input may be a set of sentences and image areas and an output may be a binary label y ∈ {0, 1} indicating whether sampled pairs match each other. For example, the encoder 140 may extract a representation of a [CLS] token as a joint representation of an input activation embedding vector-text embedding vector pair, and may then provide the extracted representation to a fully-connected (FC) layer and a sigmoid function to predict a score between 0 and 1. In this case, an output score may be represented as ϕ(W,A). ITM supervision may be concerned with the [CLS] token.

As an example, when ITM is performed, an ITM loss function maybe obtained through negative log likelihood, as illustrated in the following Equation 1.

L_{ITM}=− [symbol] _{(W,A)˜D} log(Y|ϕ(W,A)) [Equation 1]

where D represents a data set used for training. During the training, the encoder 140 may sample a positive or negative pair (w, v) from the data set D. In this case, the negative pair may be generated by replacing an image or text pair of a sample with a pair randomly selected from another sample.

According to an example embodiment, the encoder 140 may generate a text mask multimodal representation vector for a text mask concatenated embedding vector generated by masking at least one element, among elements of the text embedding vector constituting the concatenated embedding vector, and may be trained based on a masked language modeling (MLM) loss function calculated based on similarity between a masked element of the text mask concatenated embedding vector and an element, corresponding to the masked element, among elements of a text mask multimodal representation vector.

According to an example, the encoder 140 masks any element (a word token), among the elements of the text embedding vector constituting the concatenated embedding vector, and may performs MLM to guess which token is an element (a word token) masked from the elements of the text embedding vector constituting the concatenated embedding vector and the elements of the activation embedding vector. For example, the encoder 140 may determine which of the elements of the text embedding vector constituting the connection embedding vector is a masked element, and an MLM loss function may be obtained through negative log likelihood, as in the following Equation 2, depending on whether a result of the determination is correct:

L_{MLM}=− [symbol] _{(W,A)˜D} log p(wᵢ|ϕ(W_{\i}, A)) [Equation 2].

According to an example embodiment, the encoder 140 generates an image mask multimodal representation vector for an image mask concatenated embedding vector generated by masking at least one element, among elements of an activation embedding vector constituting the connection embedding vector, and may trained based on a masked activation modeling (MAM) loss function calculated based on similarity between a masked element of the image mask concatenated embedding vector and an element, corresponding to the masked element, among elements of an image mask multimodal representation vector.

According to an example, the encoder 140 may mask any element (an activation token), among elements of the activation embedding vector constituting the connection embedding vector, and may perform MAM to guess which index of the activation map is indicated by the element (the activation token) masked from the elements of the text embedding vector constituting the concatenated embedding vector and the elements of the activation embedding vector. For example, the encoder 140 may determine which of the elements of the activation embedding vector constituting the connection embedding vector is a masked element, and an MAM loss function may be obtained through negative log likelihood, as in the following Equation 3, depending on whether a result of the determination is correct:

L_{MAM}=− [symbol] _{(W,A)˜D} log p(aⱼ|W,A_{\j}) [Equation 3].

According to an example embodiment, each of the image processor 110, the text processor 120, and the encoder 140 may include a predetermined artificial neural network, and each of the artificial neural networks may be trained based on the same loss function. For example, the image processor 110, the text processor 120, and the encoder 140 may be trained based on an image-text matching (ITM) loss function, a masked language modeling (MLM) loss function, and a masked activation modeling (MAM) loss function. In particular, a text embedder and an activation embedder, respectively constituting the image processor 110 and the text processor 120, may be trained based on a loss function. However, in the image processor 110, a determination maybe selectively made as to whether to train the image encoder constituting the image processor 110.

According to an example, the loss function may be calculated based on an image-text matching (ITM) loss function, a masked language modeling (MLM) loss function, and a masked activation modeling (MAM) loss function. As an example, the loss function may be defined as a sum of the ITM loss function, the MLM loss function, and the MAM loss function, as in the following Equation 4:

L_{Total}=L_{ITM}+L_{MLM}+L_{MAM} [Equation 4].

According to an example embodiment, the apparatus for analyzing multimodal data may repeatedly perform learning by a predetermined repetition number. For example, as illustrated in FIG. 2, the apparatus for analyzing multimodal data may repeatedly perform learning by a predetermined repetition number and may learn the artificial neural networks included in the text processor, the image processor, and the encoder during the repeated learning.

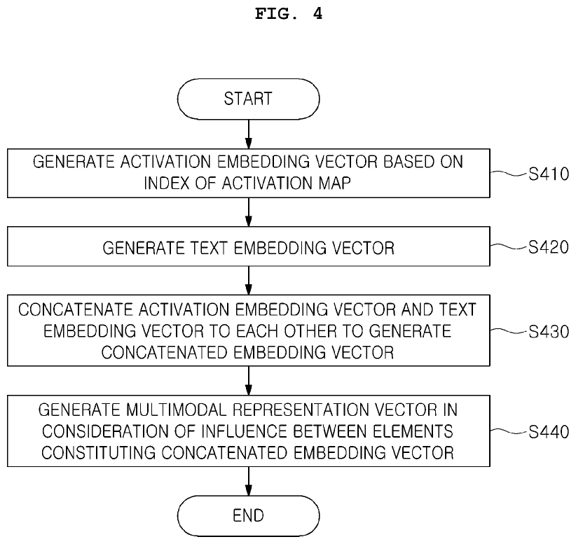

FIG. 4 is a flowchart illustrating a method for analyzing multimodal data according to an example embodiment.

According to an example embodiment, the apparatus for analyzing multimodal data may generate an activation embedding vector based on an index of an activation map obtained from image data through a convolutional neural network (S410).

According to an example, the apparatus for analyzing multimodal data may receive a data set including image data and text data, and may respectively extract image data and text data from the received data set. Then, the apparatus for analyzing multimodal data may process image data and text data.

According to an example, the apparatus for analyzing multimodal data may generate an activation map set including a plurality of activation maps for image data using a synthetic neural network. For example, the apparatus for analyzing multimodal data may encode received image data into a set of activation maps using an image encoder. The image encoder may be a convolutional neural network. As an example, the image encoder may be a ResNet (for example, ResNet101)-based convolutional neural network.

According to an example embodiment, the apparatus for analyzing multimodal data may perform global average pooling on the plurality of activation maps, constituting the activation map set, to calculate a feature value for each of the plurality of activation maps. For example, the apparatus for analyzing multimodal data may perform global average pooling on activation maps, obtained through a convolutional neural network, to generate a feature value.

According to an example embodiment, the apparatus for analyzing multimodal data may select one or more activation maps in an order of descending feature values, and may generate an index vector including indices of the selected one or more activation maps. For example, the apparatus for analyzing multimodal data may select Nₐ activation maps having highest generated feature values and may store indices of the selected activation maps.

According to an example embodiment, the apparatus for analyzing multimodal data may embed an index vector to generate an activation embedding vector. According to an example, the apparatus for analyzing multimodal data may convert a vector, including indices of activation maps, into an N-dimensional activation embedding vector using an activation embedder.

Through a series of such processes, the apparatus for analyzing multimodal data may represent input image data input as an activation embedding vector A=(a₁, . . . , a_{Na}) ∈ R\hat{ }(Nₐ×N).

According to an example embodiment, the apparatus for analyzing multimodal data may receive text data to generate a text embedding vector (S420).

According to an example, the apparatus for analyzing multimodal data may tokenize the received text data. For example, the apparatus for analyzing multimodal data may tokenize text data using a WordPiece tokenizer, and thus, may represent a sentence as a set of word tokens having independent meanings.

According to an example, the apparatus for analyzing multimodal data may convert tokenized text data, for example, a word token, into an N-dimensional vector using a text embedder. Thus, the apparatus for analyzing multimodal data may convert the received text data into a text embedding vector W=([CLS], w₁, . . . , w_{Nw}, [SEP]) ∈ [symbol] ^{(N}^{_{w}}^{+2)×N} where, [CLS] and [SEP] represent special tokens referring to beginning and end of a sentence, respectively.

According to an example embodiment, the apparatus for analyzing multimodal data may concatenate an activation embedding vector and a text embedding vector to each other to generate a concatenated embedding vector (S430).

For example, the apparatus for analyzing multimodal data may concatenate an activation embedding vector A=(a₁, . . . , a_{Na}) ∈ [symbol] \hat{ }(Nₐ×N) and a text embedding vector W=([CLS], w_{w}, . . . , w_{Nw}, [SEP]) ∈ [symbol] ^{(N}^{_{w}}^{+2)×N} to each other to generate a concatenated embedding vector V=([CLS], w₁, . . . , w_{Nw}, [SEP], a₁, . . . , a_{Na}) ∈ [symbol] ^{(N}^{_{w}}^{+2+N}^{ₐ}^{)×N}.

According to an example embodiment, the apparatus for analyzing multimodal data may generate a multimodal representation vector in consideration of an influence between elements constituting a concatenated embedding vector based on self-attention (S440).

According to an exemplary embodiment, the apparatus for analyzing multimodal data determines whether an activation embedding vector and a text embedding vector, constituting a concatenated embedding vector, match each other and may be trained based on an image-text matching (IMT) loss function calculated based on whether a result of the determination is correct.

According to an example embodiment, the apparatus for analyzing multimodal data may generate a text mask multimodal representation vector for a text mask concatenated embedding vector generated by masking at least one element, among elements of the text embedding vector constituting the concatenated embedding vector, and may be trained based on a masked language modeling (MLM) loss function calculated based on similarity between a masked element of the text mask concatenated embedding vector and an element, corresponding to the masked element, among elements of a text mask multimodal representation vector.

According to an example embodiment, the apparatus for analyzing multimodal data generates an image mask multimodal representation vector for an image mask concatenated embedding vector generated by masking at least one element, among elements of an activation embedding vector constituting the connection embedding vector, and may trained based on a masked activation modeling (MAM) loss function calculated based on similarity between a masked element of the image mask concatenated embedding vector and an element, corresponding to the masked element, among elements of an image mask multimodal representation vector.

According to an example, the loss function may be calculated based on an image-text matching (ITM) loss function, a masked language modeling (MLM) loss function, and a masked activation modeling (MAM) loss function. As an example, the loss function may be defined as a sum of the ITM loss function, the MLM loss function, and the MAM loss function, as in the following Equation 4.

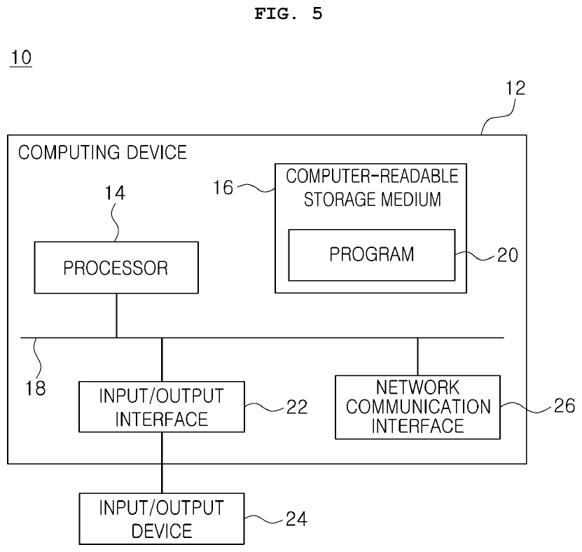

FIG. 5 is a block diagram illustrating a computing environment including a computing device according to an example embodiment.

In the illustrated embodiment, each of the components may have functions and capabilities different from those described hereinafter and additional components maybe included in addition to the components described herein.

The illustrated computing environment 10 may include a computing device 12. In an example embodiment, the computing device 12 may be one or more components included in the apparatus 120 for analyzing multimodal data. The computing device 12 may include at least one processor 12, a computer-readable storage medium 16, and a communication bus 18. The processor 14 may allow the computing device 12 to operate according to the above-described example embodiments. For example, the processor 14 may execute one or more programs stored in the computer-readable storage medium 16. The one or more programs may include one or more computer-executable commands, and the computer-executable commands maybe configured to, when executed by the processor 14, allow the computing device 12 to perform operations according to the example embodiments.

The computer-readable storage medium 16 may be configured to store computer-executable commands and program codes, program data, and/or other appropriate types of information. The programs, stored in the computer-readable storage medium 16, may include a set of commands executable by the processor 14. In an example embodiment, the computer-readable storage medium 16 may be a memory (a volatile memory such as a random access memory (RAM), a nonvolatile memory, or a combination thereof), one or more magnetic disk storage devices, optical disk storage devices, flash memory devices, other types of storage medium capable of being accessed by the computing device 12 and storing desired information, or appropriate combinations thereof.

The communication bus 18 may connect various other components of the computing device 12, including the processor 14 and the computer readable storage medium 16, to each other.

The computing device 12 may include one or more input/output interfaces 22, providing an interface for one or more input/output devices 24, and one or more network communication interfaces 26. The input/output interface 22 and the network communication interface 26 may be connected to the communication bus 18. The input/output device 24 may be connected to other components of the computing device 12 through the input/output interface 22. The illustrative input/output device 24 may be a pointing device (a mouse, a trackpad, or the like), a keyboard, a touch input device (a touchpad, a touchscreen, or the like), an input device such as a voice or sound input device, various types of sensor device, and/or an image capturing device, and/or an output device such as a display device, a printer, a speaker, and/or a network card. The illustrative input/output device 24 may be included inside the computing device 12 as a single component constituting the computing device 12, and may be connected to the computing device 12 as a device separate from the computing device 12.

As described above, more delicate multimodal expression may be secured at a higher speed than in a method according to the related art.

While example embodiments have been shown and described above, it will be apparent to those skilled in the art that modifications and variations could be made without departing from the scope of the present invention as defined by the appended claims.

What is claimed is:

1. An apparatus for analyzing multimodal data, the apparatus comprising:
an image processor configured to generate an activation embedding vector based on an index of an activation map obtained from image data through a convolutional neutral network;
a text processor configured to receive text data to generate a text embedding vector;
a vector concatenator configured to concatenate the activation embedding vector and the text embedding vector to each other to generate a concatenated embedding vector; and
an encoder configured to generate a multimodal representation vector in consideration of an influence between elements constituting the concatenated embedding vector based on self-attention,
wherein at least one of the image processor, the text processor, the vector concatenator, and the encoder comprises a hardware.

2. The apparatus of claim 1, wherein the image processor is configured to generate an activation map set comprising a plurality of activation maps for the image data, using a synthetic neutral network.

3. The apparatus of claim 2, wherein the image processor is configured to perform global average pooling on the plurality of activation maps to calculate a feature value for each of the plurality of activation maps.

4. The apparatus of claim 3, wherein the image processor is configured to select one or more activation maps among the plurality of activation maps, and each of the selected one or more activation maps has the feature value greater than each of non-selected activation maps, and is configured to generate an index vector including indices of the selected one or more activation maps.

5. The apparatus of claim 4, wherein the image processor is configured to embed the index vector to generate an activation embedding vector.

6. The apparatus of claim 1, wherein the encoder is configured to:
determine whether the text embedding vector and the activation embedding vector constituting the concatenated embedding vector match each other; and
be trained based on an image-text matching (ITM) loss function calculated based on whether a result of the determination is correct.

7. The apparatus of claim 1, wherein the encoder is configured to:
generate a text mask multimodal representation vector for a text mask concatenated embedding vector generated by masking at least one element, among elements of the text embedding vector constituting the concatenated embedding vector; and
be trained based on a masked language modeling (MLM) loss function calculated based on similarity between a masked element of the text mask concatenated embedding vector and an element, corresponding to the masked element, among elements of a text mask multimodal representation vector.

8. The apparatus of claim 1, wherein the encoder is configured to:
generate an image mask multimodal representation vector for an image mask concatenated embedding vector generated by masking an element among elements of an activation embedding vector constituting a concatenated embedding vector; and
be trained based on a masked activation modeling (MAM) loss function calculated based on similarity between the masked element of the image mask concatenated embedding vector and an element, corresponding to the masked element, among elements of the image mask multimodal representation vector.

9. The apparatus of claim 1, wherein the image processor, the text processor, and the encoder are configured to be trained based on the same loss function.

10. The apparatus of claim 9, wherein the loss function is calculated based on an image-text matching (ITM) loss function, a masked language modeling (MLM) loss function, and a masked activation modeling (MAM) loss function.

11. A method for analyzing multimodal data, the method performed by a computing device comprising a processor and a computer-readable storage medium storing a program comprising a computer-executable command executed by the processor to perform operations comprising:
an image processing operation in which an activation embedding vector is generated based on an index of an activation map obtained from image data through a convolutional neural network;
a text processing operation in which text data is received to generate a text embedding vector;
a vector concatenation operation in which the activation embedding vector and the text embedding vector are concatenated to each other to generate a concatenated embedding vector; and
an encoding operation in which a multimodal representation vector is generated in consideration of an influence between elements, constituting the concatenated embedding vector, based on self-attention.

12. The method of claim 11, wherein, in the image processing operation, an activation map set including a plurality of activation maps for the image data is generated using a synthetic neural network.

13. The method of claim 12, wherein, in the image processing operation, global average pooling is performed on the plurality of activation maps to calculate a feature value of each of the plurality of activation maps.

14. The method of claim 13, wherein, in the image processing operation, one or more activation maps are selected among the plurality of activation maps, and each of the selected one or more activation maps has the feature value greater than each of non-selected activation maps, and an index vector including indices of the selected one or more activation maps is generated.

15. The method of claim 14, wherein, in the image processing operation, the index vector is embedded to generate an activation embedding vector.

16. The method of claim 11, wherein, in the encoding operation, a determination is made as to whether the text embedding vector and the activation embedding vector, constituting the concatenated embedding vector, match each other, and training is performed based on an image-text matching (IMT) loss function calculated based on whether a result of the determination is correct.

17. The method of claim 11, wherein, in the encoding operation, a text mask multimodal representation vector for a text mask concatenated embedding vector generated by masking at least one element, among elements of the text embedding vector constituting the concatenated embedding vector, is generated, and training is performed based on a masked language modeling (MLM) loss function calculated based on similarity between a masked element of the text mask concatenated embedding vector and an element, corresponding to the masked element, among elements of a text mask multimodal representation vector.

18. The method of claim 11, wherein, in the encoding operation, an image mask multimodal representation vector for an image mask embedding vector generated by masking an element, among elements of an activation embedding vector constituting a concatenated embedding vector, is generated, and training is performed based on a masked activation modeling (MAM) loss function calculated based on similarity between the masked element of the image mask concatenated embedding vector and an element, corresponding to the masked element, among elements of the image mask multimodal representation vector.

19. The method of claim 11, wherein, in the image processing operation, the text processing operation, and the encoding operation, trainings are performed based on the same loss function.

20. The method of claim 19, wherein, the loss function is calculated based on an image-text matching (ITM) loss function, a masked language modeling (MLM) loss function, and a masked activation modeling (MAM) loss function.
